(19) United States
(12) Patent Application Publication
(10) Pub. No.: US 2015/0301637 A1
(43) Pub. Date: Oct. 22, 2015

(54) TOUCH PANEL AND TOUCH PANEL DISPLAY DEVICE

(71) Applicant: InnoLux Corporation, Miao-Li County (TW)

(72) Inventors: Chih-Chang CHEN, Miao-Li County (TW); Ping-Hsu CHENG, Miao-Li County (TW)

(21) Appl. No.: 14/687,062

(22) Filed: Apr. 15, 2015

(30) Foreign Application Priority Data
Apr. 22, 2014 (TW) 103114484

(51) Int. Cl. G06F 3/041

(52) U.S. Cl. CPC G06F 3/041

(57) ABSTRACT

A touch panel is provided. The touch panel includes a substrate having a viewing area and a peripheral area and a light shielding layer disposed over the peripheral area of the substrate. In addition, the light shielding layer has a top surface and a first sloped sidewall. The touch panel further includes a sensing electrode layer disposed over the viewing area of the substrate, and the sensing electrode layer includes an extending electrode extending from the viewing area of the substrate to the light shielding layer. In addition, the extending electrode over the top surface of the light shielding layer has a first thickness and the extending electrode over the first sloped sidewall has a second thickness smaller than the first thickness.

### CROSS REFERENCE TO RELATED APPLICATIONS

This Application claims priority of Taiwan Patent Application No. 103114484, filed on Apr. 22, 2014, the entirety of which is incorporated by reference herein.

### BACKGROUND OF THE DISCLOSURE

1. Field of the Invention

The present invention relates to a touch-control technique, and in particular relates to a touch panel and a touch panel display device.

2. Description of the Related Art

In recent years, touch panel devices have been widely used in all kinds of electronic products, such as cell phones, personal data assistants (PDA), and tablet personal computers. Touch panels can be generally divided into resistance-type, capacitance-type, acoustic type, or infrared ray-type. Usually, a touch panel is a transparent rectangular panel and is stacked onto a side of a liquid crystal display device. By using a flexible printed circuit board, the touch panel can be connected to the liquid crystal display device and a control device, such that the device can be controlled by touch.

A touch panel display device, which combines a touch panel and a liquid crystal display, enables its users to input signals by touching the device with their hands or other objects. Accordingly, additional input devices, such as keyboards, mouse devices, or remote controls, are not required.

Thinned touch panels are continuously developed. In addition, these thinned touch panels have become more and more popular due to their thinness. However, development of the thinned touch panels is still challenging.

### BRIEF SUMMARY OF THE DISCLOSURE

In some embodiments, a touch panel is provided. The touch panel includes a substrate having a viewing area and a peripheral area and a light shielding layer disposed over the peripheral area of the substrate. In addition, the light shielding layer has a top surface and a first sloped sidewall. The touch panel further includes a sensing electrode layer disposed over the viewing area of the substrate. In addition, the sensing electrode layer includes an extending electrode extending from the viewing area of the substrate to the light shielding layer, and the extending electrode over the top surface of the light shielding layer has a first thickness, and the extending electrode over the first sloped sidewall has a second thickness, which is smaller than the first thickness.

In some embodiments, a touch panel display device is provided. The touch panel display device includes a display panel and a touch panel disposed over the display panel. In addition, the touch panel includes a substrate having a viewing area and a peripheral area, and a light shielding layer is disposed over the peripheral area of the substrate. The light shielding layer has a top surface and a first sloped sidewall. The touch panel further includes a sensing electrode layer disposed over the viewing area of the substrate. In addition, the sensing electrode layer comprises an extending electrode extending from the viewing area of the substrate to the light shielding layer, and the extending electrode over the top surface of the light shielding layer has a first thickness, and the extending electrode over the first sloped sidewall has a second thickness being smaller than the first thickness.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a top-view representation of a touch panel in accordance with some embodiments of the disclosure.

FIG. 2 is a top-view representation of a sensing electrode layer in the viewing area of the substrate in accordance with some embodiments.

FIGS. 3A to 3E are cross-sectional representations of various stages of manufacturing a touch panel in accordance with some embodiments.

FIG. 4 is an enlarged representation of the region shown in FIG. 3B.

FIG. 5A is a cross-sectional representation of a touch panel in accordance with some other embodiments.

FIG. 5B is an enlarged representation of the region of the touch panel shown in FIG. 5A.

FIG. 6A is a cross-sectional representation of a touch panel in accordance with some other embodiments.

FIG. 6B is an enlarged representation of the region of the touch panel shown in FIG. 6A.

FIG. 7 is a cross-sectional representation of a touch panel display device 700 in accordance with some embodiments.

### DETAILED DESCRIPTION OF THE DISCLOSURE

The following description is of the best-contemplated mode of carrying out the invention. This description is made for the purpose of illustrating the general principles of the invention and should not be taken in a limiting sense. The scope of the invention is best determined by reference to the appended claims.

Moreover, the formation of a first feature over or on a second feature in the description that follows may include embodiments in which the first and second features are formed in direct contact, and may also include embodiments in which additional features may be formed between the first and second features, such that the first and second features may not be in direct contact.

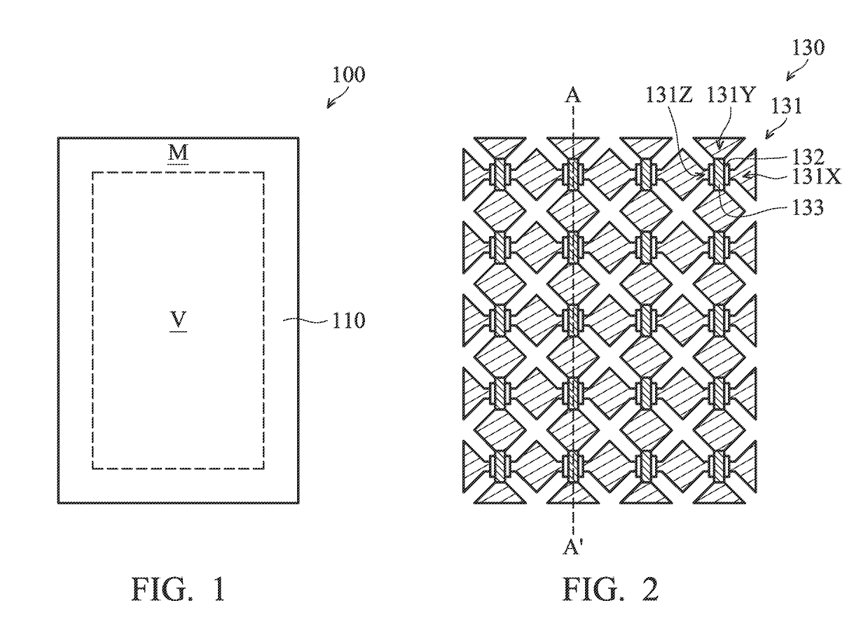

FIG. 1 is a top-view representation of a touch panel 100 in accordance with some embodiments of the disclosure. The touch panel 100 includes a substrate 110, and the substrate 110 has a viewing area V and a peripheral area M. The peripheral area M surrounds the viewing area V. FIG. 2 is a top-view representation of a sensing electrode layer 130 in the viewing area V of the substrate 110 in accordance with some embodiments. The sensing electrode layer 130 may include an electrode portion 131, and the electrode portion 131 includes a plurality of first electrodes 131X aligned in row, a plurality of second electrodes 131Y aligned in column, and a plurality of connection portions 131Z connecting the first electrodes 131X adjacent to each other in the same row. The sensing electrode layer 130 may further include a plurality of cross-linking portions 133 and a plurality of insulating portions 132. The cross-linking portions 133 are configured to connect the second electrodes 131Y adjacent to each other in the same column. The insulating portions 132 are disposed between the connection portions 131Z and the cross-linking portions 133 to electrically insulate the connection portions 131Z and the cross-linking portions 133.

It should be noted that the sensing electrode layer 130 shown in FIG. 2 is merely used as an example for better understanding the disclosure. The number and type of the elements, such as first electrodes 131X and the second electrodes 131Y, are not intended to be limiting. In addition, the shapes of the first electrodes 131X and the second electrodes 131Y are not limited to the quadrangle or triangle shown in FIG. 2. That is, elements in the sensing electrode layer in other embodiments may have other shapes and/or in other pattern, and the scope of the disclosure is not intended to be limiting.

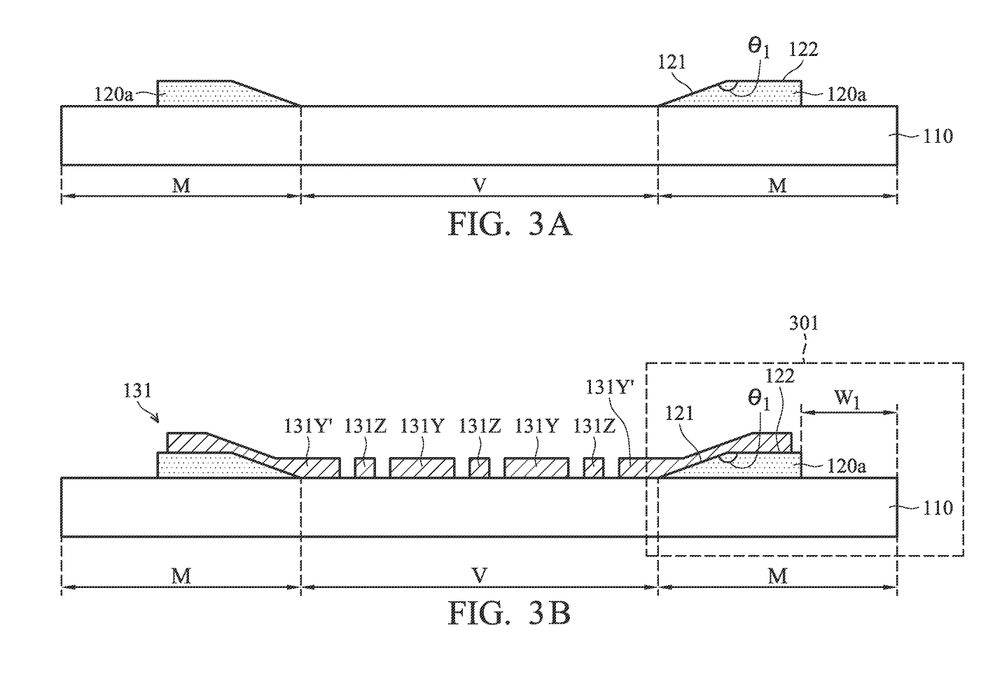

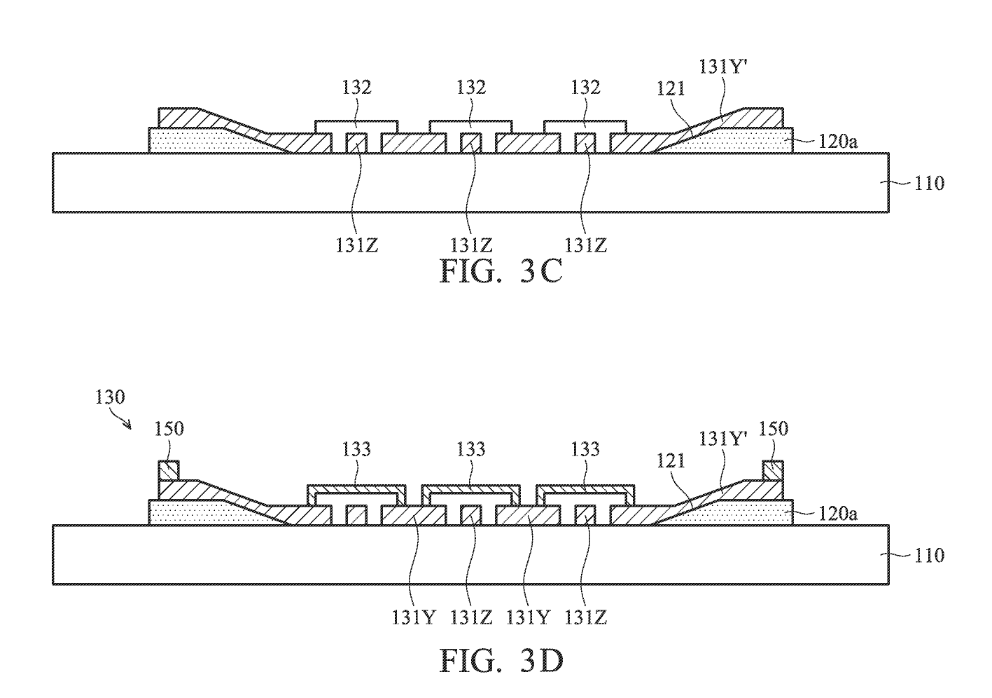

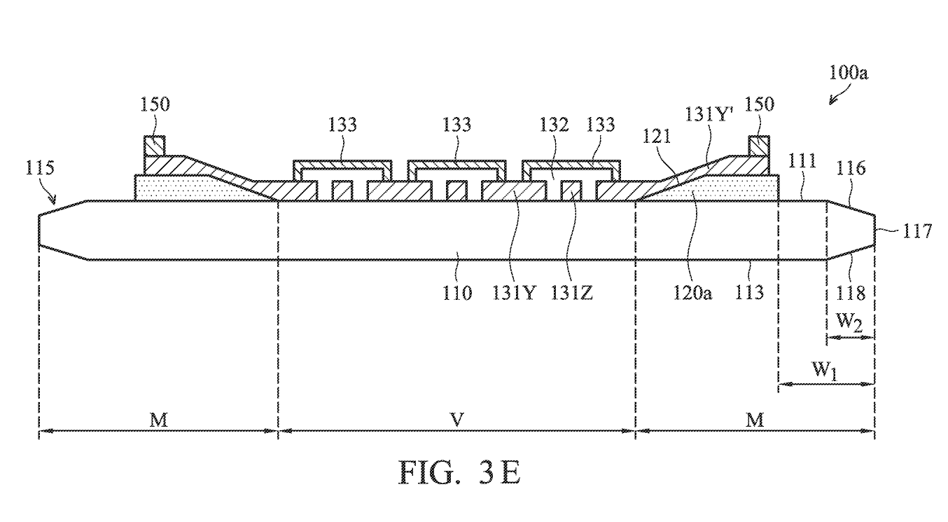

FIGS. 3A to 3E are cross-sectional representations of various stages of manufacturing a touch panel 100a (e.g. alone line A-A′ shown in FIG. 2) in accordance with some embodiments. As shown in FIG. 3A, the substrate 110 is provided. The substrate 110 has the viewing area V and peripheral area M positioned beside the viewing area V. The substrate 110 may be made of transparent insulating materials, such as glass, poly(ethylene terephthalate) (PET), polyethersulfone (PES), polyarylate (PAR), polyethylene naphthalate (PEN), polyphenylene sulfide (PPS), polyallylate, polycarbonates (PC), or the like. The substrate 110 may be a rigid substrate or a flexible substrate. The substrate 110 may have a flat, curved, or irregular shape.

A light shielding layer 120a is formed over the peripheral area M of the substrate 110. As shown in FIG. 3A, the light shielding layer 120a has a first sloped sidewall 121 at the side that is close to the viewing area V. The light shielding layer 120a has a first angle θ₁ between the top surface 122 and the first sloped sidewall 121. In some embodiments, the first angle θ₁ is in a range from about 135° to about 165°. If the first angle θ₁ is too large, the light shielding layer 120a may extend into the viewing area V, affecting the display performance of the device. In addition, if the first angle θ₁ is too large, the portion of the light shielding layer 120a at the first sloped sidewall may be so thin that leakage of light may occur at the region near the viewing area V. On the other hand, if the first angle θ₁ is too small, electrodes, which will be formed over the light shielding layer 120a in subsequent processes, may break due to the large angle between the top surface 122 and the first sloped sidewall 121.

In some embodiments, the light shielding layer 120a has a thickness in a range from about 1.25 μm to about 1.55 μm. The light shielding layer 120a may be formed by coating a light shading material and then patterning the light shading material to form the light shielding layer 120a having the first sloped sidewall 121. The light shading material may be patterned by exposure and develope processes. The light shading material may be, but is not limited to, a colored photoresist material including resins, dyes, a light sensing agent, and a solvent. In some embodiments, the light shielding layer 120a is made of a black photoresist material, such as polyimide or ink.

After the light shielding layer 120a is formed, the electrode portions 131 are formed over the viewing area V of the substrate 110, as shown in FIG. 3B. The electrode portions 131 include a plurality of first electrodes 131X aligned in row (not shown in FIG. 3, referring to FIG. 2), a plurality of second electrodes 131Y aligned in column, and a plurality of connection portions 131Z connecting the adjacent first electrodes 131X. It should be noted that although the numbers of first electrode 131X, second electrodes 131Y, and connection portions 131Z shown in FIG. 2 and FIG. 3B are different, they are merely an example for better understanding the concept of the disclosure. That is, the first electrodes, the second electrodes, and the connection portions may be in another pattern, and the scope of the disclosure is not intended to be limiting.

As shown in FIG. 3B, the electrode portions 131 further include extending electrodes 131Y′, and the extending electrode 131Y′ extends from the viewing area V of the substrate 110 to over the light shielding layer 120a. In addition, the thickness of the extending electrode 131Y′ over the first sloped sidewall is smaller than its thickness over the top surface 122 of the light shielding layer 120a and is also smaller than its thickness over the viewing area V.

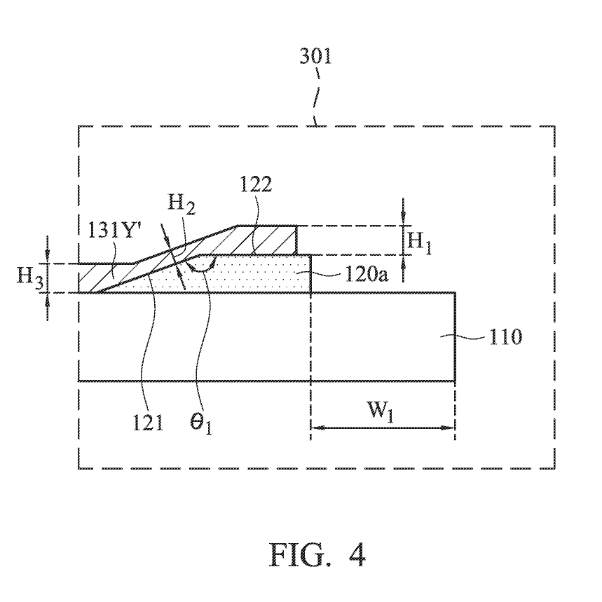

The details of structures of the light shielding layer 120a and the extending electrode 131Y′ are shown in FIG. 4. FIG. 4 is an enlarged representation of the region 301 shown in FIG. 3B. As shown in FIG. 4, the extending electrode 131Y′ has a first thickness H₁ over the top surface 122 of the light shielding layer 120a and has a second thickness H₂ over the first sloped sidewall 121 of the light shielding layer 120. In addition, the extending electrode 131Y′ has a third thickness H₃ over the viewing area V of the substrate 110. In some embodiments, the first thickness H₁ is substantially equal to the third thickness H₃, and the second thickness H₂ is smaller than both the first thickness H₁ and the third thickness H₃.

In some embodiments, the ratio of the second thickness H₂ to the first thickness H₁ is in a range from about 0.6 to about 0.9. By forming the extending electrode 131Y′ having a smaller thickness at the first sloped sidewall of the light shielding layer 120a, the mura effect (e.g. uneven lightness) at the border region between the viewing area V and the peripheral area M can be reduced. Accordingly, if the ratio of the second thickness H₂ to the first thickness H₁ is too large (i.e. the difference between the two thicknesses being too small), the mura effect may not be reduced. On the other hand, if the ratio of the second thickness H₂ to the first thickness H₁ is too small (i.e. the difference between the two thicknesses being too large), the extending electrode 131Y′ may tend to be broken.

In some embodiments, the first thickness H₁ of the extending electrode 131Y′ over the top surface 122 of the light shielding layer 120 is in a range from about 50 nm to about 70 nm. In some embodiments, the second thickness H₂ of the extending electrode 131Y′ over the first sloped sidewall 121 of the light shielding layer 120 is in a range from about 30 nm to about 63 nm. In some embodiments, the third thickness H₃ of the extending electrode 131Y′ over the viewing area V of the substrate 110 is in a range from about 50 nm to about 70 nm.

As shown in FIG. 4, the distance between the edge of the light shielding layer 120a and the edge of the substrate 110 is defined as the first length W₁. In some embodiments, the first length W₁ is in a range from about 150 μm to about 300 μm.

Referring back to FIG. 3B, the electrode portions 131 may be formed by depositing a transparent conductive material and patterning the transparent conductive material by photolithography and etching processes, and the first electrodes 131X, the second electrodes 131Y, and the connection portions 131Z connecting the adjacent first electrodes 131X. The transparent conductive material may be deposited by sputtering, physical vapor deposition (PVD), chemical vapor deposition (CVD), or other applicable processes. The photolithography process includes coating (e.g. spin coating) photoresist material, soft baking, mask aligning, exposure, post-exposure baking, photoresist develop, washing, drying (e.g. hard baking), other applicable processes, or a combination thereof. The etching process includes dry etching, wet etching, or reactive ion etching.

As described previously, when the transparent conductive material is patterned to form the extending electrodes 131Y′, the etching process is adjusted to form the extending electrodes 131Y′ with a thinner thickness at (i.e. over) the first slide sidewall 121 of the light shielding layer 120a and a thicker thickness at (i.e. over) the top surface 122 of the light shielding layer 120a and at (i.e. over) the viewing area V.

The electrode portions 131 may be made of transparent conductive materials such as indium tin oxide (ITO), indium zinc oxide (IZO), cadmium tin oxide (CTO), aluminum zinc oxide (AZO), indium tin zinc oxide (ITZO), zinc oxide, cadmium oxide (CdO), hafnium oxide (HfO), indium gallium zinc oxide (InGaZnO), indium gallium zinc magnesium oxide (InGaZnMgO), indium gallium magnesium oxide (InGaMgO), indium gallium aluminum oxide (InGaAlO), or a combination thereof.

After the electrode portions 131 are formed, the insulating portions 132 are formed over the connection portions 131Z of the electrode portions 131, as shown in FIG. 3C. The insulating portions 132 may be formed by forming an insulating layer, such as photoresist layer, and patterning the insulating layer by photolithography or printing. The insulating portions 132 may be made of organic or inorganic insulating materials, such as polyimide, epoxy resin, silicon oxide, silicon nitride, or the like.

Afterwards, the cross-linking portions 133 are formed over insulating portions 132, as shown in FIG. 3D. The cross-linking portions 133 may be made of metal conductive wires, transparent conductive materials, or a combination thereof. The metal conductive wires may include, but are not limited to, conductive wires made of copper (Cu), silver (Ag), aluminum (Al), or a combination thereof. The transparent conductive materials may include, but are not limited to, indium tin oxide (ITO), indium zinc oxide (IZO), cadmium tin oxide (CTO), aluminum zinc oxide (AZO), indium tin zinc oxide (ITZO), zinc oxide, cadmium oxide (CdO), hafnium oxide (HfO), indium gallium zinc oxide (InGaZnO), indium gallium zinc magnesium oxide (InGaZnMgO), indium gallium magnesium oxide (InGaMgO), indium gallium aluminum oxide (InGaAlO), or a combination thereof. In some embodiments, the cross-linking portions 133 are formed by lithography and etching processes or printing processes.

In addition, a signal trace layer 150 is formed over the extending electrodes 131Y′ over the light shielding layer 120a, as shown in FIG. 3D. The signal trace layer 150 and the extending electrodes 131Y′ are electrically connected. The signal trace layer 150 may be made of metals, transparent conductive materials, or a combination thereof. The metals used to form the signal trace layer 150 may include, but are not limited to, silver or aluminum. The transparent conductive materials may include, but are not limited to, indium tin oxide. In some embodiments, the signal trace layer 150 is made of metal to have a better conductivity. The signal trace layer 150 may be formed by lithography and etching processes or printing processes. In some embodiments, the cross-linking portions 133 and the signal trace layer 150 are formed by the same material in the same process. That is, the cross-linking portions 133 and the signal trace layer 150 may be formed by the process at the same time, such that manufacturing processes can become simpler and the cost of forming the device can be reduced.

After the cross-linking portions 133 and the signal trace layer 150 are formed, an edge grinding process is performed to the substrate 110 in accordance with some embodiments. The sharp edge of the substrate 110 (e.g. the tips of the corners of the substrate 110) is ground during the edge grinding process, such that the substrate 110 can have an obtuse corner at its edge. The obtuse corner of the substrate 110 enables reducing the risks of breaking of the substrate 110 during subsequent packaging processes. In some embodiments, after the edge grinding process, the ground obtuse corner has a second width W₂, such as in a range from about 120 μm to about 180 μm. The second width W₂ is defined as the width of the grinded portion of the substrate 110.

As shown in FIG. 3E, the substrate 110 has a top surface 111, a bottom surface 113, and a sidewall 115. In addition, after the edge grinding process, the sidewall 115 of the substrate 110 is divided into an upper portion 116, a middle portion 117, and a bottom portion 118. In some embodiments, the angle between the top surface 111 of the substrate 110 and the upper portion 116 of the sidewall 115 of the substrate 110 is in a range from about 145° to about 155°. In some embodiments, the angle between the bottom surface 113 of the substrate 110 and the bottom portion 118 of the sidewall 115 of the substrate 110 is in a range from about 145° to about 155°.

As described previously, the light shielding layer 120a has the first sloped sidewall 121, which can prevent the extending electrode 131Y′ formed thereon from breaking In addition, the thickness of the extending electrodes 131Y′ is thinner over the first sloped sidewall 121 of the light shielding layer 120a but is thicker over the top surface 122 of the light shielding layer 120a. Therefore, mura effect (e.g. uneven lightness) at the border region between the viewing area V and the peripheral area M can be reduced.

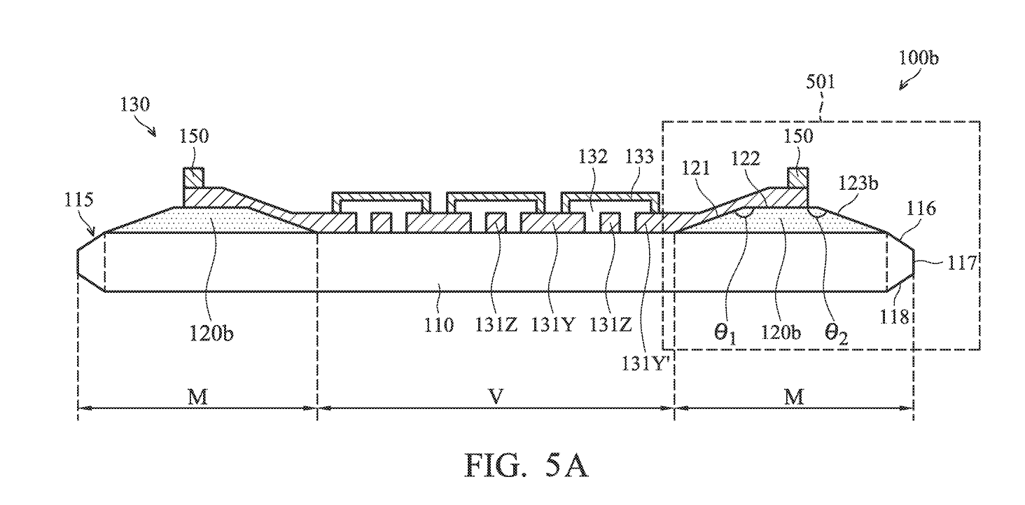

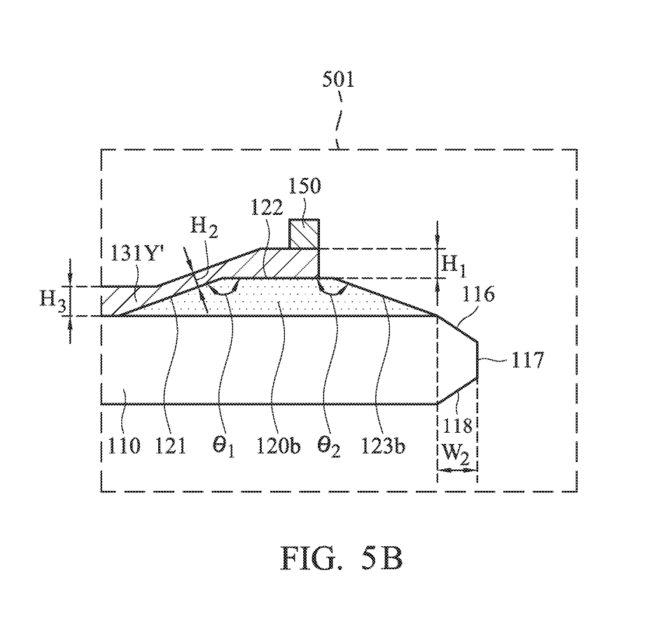

FIG. 5A is a cross-sectional representation of a touch panel 100b in accordance with some other embodiments. The touch panel 100b shown in FIG. 5A is similar to the touch panel 100a shown in FIG. 3E. However, a light shielding layer 120b of the touch panel 100b further has a second sloped sidewall 123b.

Methods and materials used to form the light shielding layer 120b may be similar to those used to form the light shielding layer 120a. For example, a light shading material may be coated onto the substrate 110, and then the light shading material may be patterned to form a light shielding layer 120b having a first sloped sidewall 121 and a second sloped sidewall 123b. The first sloped sidewall 121 of the light shielding layer 120b may be at the side of the light shielding layer 120b closer to the viewing area V, and the second sloped sidewall 123b of the light shielding layer 120b may be at the side of the light shielding layer 120b opposite to the viewing area V. After the light shielding layer 120b is formed, the sensing electrode layer 130 is formed, as shown in FIG. 3E. In addition, the extending electrodes 131Y′ extend from the viewing area V to over the light shielding layer 120b, and the thickness of the extending electrodes 131Y′ is thinner over the first sloped sidewall 121 of the light shielding layer 120a but is thicker over the top surface 122 of the light shielding layer 120a. It should be noted that the elements in the touch panel 100b are similar to, or the same as, those in the touch panel 100a described previously, and therefore the methods and materials for forming them are not repeated herein.

FIG. 5B is an enlarged representation of the region 501 of the touch panel 100b shown in FIG. 5A. Similar to the touch panel 100a shown in FIG. 3E, the substrate 110 of the touch panel 100b has the sidewall 115 after the edge grinding process. The sidewall 115 includes the upper portion 116, the middle portion 117, and the bottom portion 118, and the inclination of the upper portion 116, the middle portion 117, and the bottom portion 118 of the sidewall 115 are all different. In some embodiments, after the edge grinding process, the grinded obtuse corner has a second width W₂, such as in a range from about 120 μm to about 180 μm. In addition, in some embodiments, the edge of the top surface 111 of the substrate 102 not covered by the light shielding layer 120b is completely grinded during the edge grinding process, such that the edge of the light shielding layer 120b and the edge of the top surface 111 of the substrate 102 are aligned to each other. Therefore, the risk of light leakage of the touch panel is reduced. Furthermore, since the second sloped sidewall 123b of the light shielding layer 120b is not grinded during the edge grinding process, the inclination of the second sloped sidewall 123b of the light shielding layer 120b is different from that of the upper portion 116 of the sidewall 115 of the substrate 110.

More specifically, the light shielding layer 120b has a top surface 122, a first sloped sidewall 121, and a second sloped sidewall 123b. The top surface 122 of the light shielding layer 120b and the first sloped sidewall 121 have a first angle θ₁ therebetween, and the top surface 122 of the light shielding layer 120b and the second sloped sidewall 123b have a second angle θ₂ therebetween. In some embodiments, the first angle θ₁ is substantially equal to the second angle θ₂. In some embodiments, the second angle θ₂ is in a range from about 135° to about 165°.

As described previously, the light shielding layer 120b also has the first sloped sidewall 121, and therefore the breakage of the extending electrodes 131Y′ formed thereon can be prevented. In addition, the thickness of the extending electrodes 131Y′ formed over the first sloped sidewall 121 of the light shielding layer 120b is smaller than the thickness of the extending electrodes 131Y′ formed over the top surface 122 of the light shielding layer 120b. Therefore, the mura effect (e.g. uneven lightness) at the border region between the viewing area V and the peripheral area M can be reduced. In addition, the light shielding layer 120b further includes the second sloped sidewall 123b extending to the portion close to the edge of the substrate 110. Therefore, the light leakage of the touch panel 100b can be reduced. Accordingly, when the touch panel 100b shown in FIGS. 5A and 5B is formed, formation of a second ink layer for avoiding light leakage at the edge of the substrate may not be required. Therefore, the processes for manufacturing the touch panel 100b may be simplified and the cost may be reduced. In addition, the second sloped sidewall 123b may also be used as a protection layer of the substrate 110, such that the risk of breakage of the substrate 110 during the subsequent edge grinding process or packaging processes may be reduced.

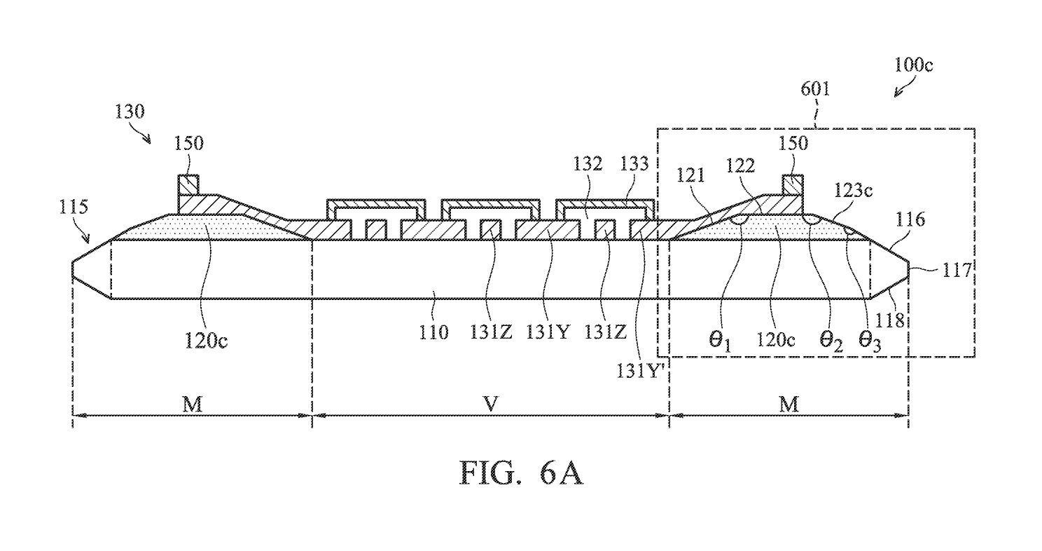

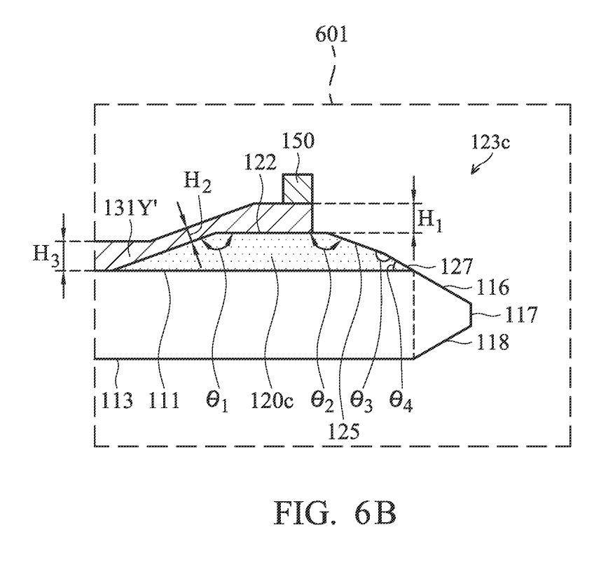

FIG. 6A is a cross-sectional representation of a touch panel 100c in accordance with some other embodiments. The touch panel 100c shown in FIG. 6A is similar to the touch panel 100b shown in FIG. 5A, except a second sloped sidewall 123c of a light shielding layer 100c of the touch panel 100c has a third angle θ₃ between its upper portion 125 and its bottom portion 127.

The method and materials used to form the light shielding layer 120c may be similar to those used to form the light shielding layer 120b shown in FIG. 5A. For example, a light shading material is coated to the substrate 110, and the light shading material is patterned to form the light shielding layer 120c having the first sloped sidewall 121 and the second sloped sidewall, which is the same as the light shielding layer 120b shown in FIG. 5A at this stage. Afterwards, the edge grinding process described previously is performed, and the second sloped sidewall of the light shielding layer is further grinded to form the second sloped sidewall 123c having the upper portion 125 and the bottom portion 127. In addition, the inclination of the bottom portion 127 of the second sloped sidewall 123c is equal to that of the upper portion 116 of the sidewall 115 of the substrate 110.

It should be noted that the touch panel 100c also includes elements such as the sensing electrode layer 130 as shown in FIG. 3E, and the extending electrodes 131Y′ extend from the viewing area V to the light shielding layer 120c. In addition, the thickness of the extending electrodes 131Y′ over the first sloped sidewall 121 of the light shielding layer 120c is smaller than that over the top surface 122 of the light shielding layer 120c. Furthermore, those elements in the touch panel 100c are similar to, or the same as, those in the touch panel 100b, and therefore the methods and materials for forming them are not repeated herein.

FIG. 6B is an enlarged representation of the region 601 of the touch panel 100c shown in FIG. 6A. After the edge grinding process is performed, the light shielding layer 120c has the top surface 122, the first sloped sidewall 121, and the second sloped sidewall 123c, and the second sloped sidewall 123c has the upper portion 125 and the bottom portion 127. The top surface 122 of the light shielding layer 120c and the first sloped sidewall 121 have a first angle θ₁ therebetween, and the top surface 122 and the second sloped sidewall 123c have a second angle θ₂ therebetween. In addition, the upper portion 125 of the second sloped sidewall 123c and the bottom portion 127 of the second sloped sidewall 123c have a third angle θ₃ therebetween, and the bottom portion 127 of the second sloped sidewall 123c and the top surface 111 of the substrate 110 have a fourth angle θ₄ therebetween. In some embodiments, the third angle θ₃ between the upper portion 125 of the second sloped sidewall 123c and the bottom portion 127 of the second sloped sidewall 123c is smaller than 180°, such as in a range from about 130° to about 170°. In some embodiments, the fourth angle θ₄ between the bottom portion 127 of the second sloped sidewall 123c and the top surface 111 of the substrate 110 is in a range from about 25° to about 35°.

As described previously, the light shielding layer 120c also has the first sloped sidewall 121 and the second sloped sidewall 123c, and therefore the breakage of the extending electrodes 131Y′ formed thereon can be prevented and mura effect (e.g. uneven lightness) at the border region between the viewing area V and the peripheral area M may be reduced.

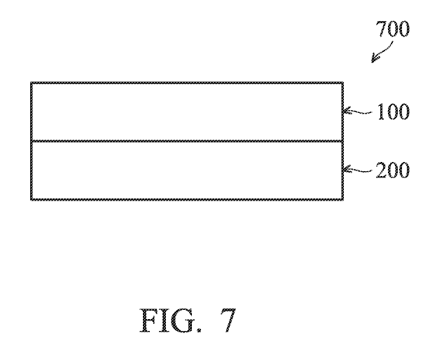

FIG. 7 is a cross-sectional representation of a touch panel display device 700 in accordance with some embodiments. The touch panel display device 700 includes a touch panel 100 and a display panel 200. The touch panel 100 may be one of the touch panels 100a, 100b, and 100c described previously. The display panel 200 may be a liquid crystal display (LCD) panel or an organic light-emitting diode (OLED) display panel. In some embodiments, the liquid crystal display includes a thin film transistor substrate and a color filter substrate disposed opposite to the thin film transistor substrate. The thin film transistor substrate further includes thin film transistor structure, pixel electrodes, scanning line, data lines, or the like. In some embodiments, the organic light-emitting diode display includes a cathode layer, an organic light-emitting diode layer, an anode layer, a thin film transistor layer, a bottom substrate, an upper substrate, or the like. In addition, the organic light-emitting diode layer includes a hole transporting layer (HTL), an emitting layer, and an electron transporting layer (ETL) in accordance with some embodiments.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A touch panel, comprising
a substrate having a viewing area and a peripheral area;
a light shielding layer disposed over the peripheral area of the substrate, wherein the light shielding layer has a top surface and a first sloped sidewall; and
a sensing electrode layer disposed over the viewing area of the substrate,
wherein the sensing electrode layer comprises an extending electrode extending from the viewing area of the substrate to the light shielding layer, and the extending electrode over the top surface of the light shielding layer has a first thickness and the extending electrode over the first sloped sidewall has a second thickness smaller than the first thickness.

2. The touch panel as claimed in claim 1, wherein a ratio of the second thickness to the first thickness is in a range of about 0.6 to about 0.9.

3. The touch panel as claimed in claim 1, wherein a first angle between the top surface of the light shielding layer and the first sloped sidewall of the light shielding layer is in a range from about 135° to about 165°.

4. The touch panel as claimed in claim 1, wherein the light shielding layer has a second sloped sidewall, and the first sloped sidewall of the light shielding layer is at a side that is close to the viewing area and the second sloped sidewall of the light shielding layer is at a side that is opposite to the viewing area.

5. The touch panel as claimed in claim 4, wherein a second angle between the second sloped sidewall of the light shielding layer and the top surface of the light shielding layer is in a range from about 135° to about 165°.

6. The touch panel as claimed in claim 4, wherein the second sloped sidewall comprises an upper portion and a bottom portion, and a third angle between the upper portion of the second sloped sidewall and the bottom portion of the second sloped sidewall of the second sloped sidewall is in a range from about 130° to about 170°.

7. The touch panel as claimed in claim 6, wherein a fourth angle between the bottom portion of the second sloped sidewall the second sloped sidewall of the light shielding layer and a top surface of the substrate is in a range from about 25° to about 35°.

8. The touch panel as claimed in claim 1, wherein the substrate has a top surface and a sidewall, and the sidewall of the substrate comprises an upper portion, a middle portion, and a bottom portion, and an inclination of the upper portion of the sidewall of the substrate, an inclination of the middle portion of the sidewall of the substrate, and inclination of the bottom portion of the sidewall of the substrate are all different.

9. The touch panel as claimed in claim 8, wherein an angle between the upper portion of the sidewall of the substrate and the top surface of the substrate is in a range from about 145° to about 155°.

10. The touch panel as claimed in claim 6, wherein the substrate has a top surface and a sidewall, the sidewall of the substrate comprises an upper portion, a middle portion, and a bottom portion, and an inclination of the bottom portion of the second sloped sidewall of the second sloped sidewall of the light shielding layer and an inclination of the upper portion of the sidewall of the substrate are substantially equal to each other.

11. The touch panel as claimed in claim 1, wherein the extending electrode has a than the second thickness of the extending electrode over the first sloped sidewall of the light shielding layer.

12. A touch panel display device, comprising
a display panel; and
a touch panel disposed over the display panel, wherein the touch panel comprises:
a substrate having a viewing area and a peripheral area;
a light shielding layer disposed over the peripheral area of the substrate, wherein the light shielding layer has a top surface and a first sloped sidewall; and
a sensing electrode layer disposed over the viewing area of the substrate,
wherein the sensing electrode layer comprises an extending electrode extending from the viewing area of the substrate to the light shielding layer, the extending electrode over the top surface of the light shielding layer has a first thickness and the extending electrode over the first sloped sidewall has a second thickness smaller than the first thickness.

13. The touch panel display device as claimed in claim 12, wherein a ratio of the second thickness to the first thickness is in a range of about 0.6 to about 0.9.

14. The touch panel display device as claimed in claim 12, wherein a first angle between the top surface of the light shielding layer and the first sloped sidewall of the light shielding layer is in a range from about 135° to about 165°.

15. The touch panel display device as claimed in claim 12, wherein the light shielding layer has a second sloped sidewall, and the first sloped sidewall of the light shielding layer is at a side that is close to the viewing area and the second sloped sidewall

16. The touch panel display device as claimed in claim 15, wherein a second angle between the second sloped sidewall of the light shielding layer and the top surface of the light shielding layer is in a range from about 135° to about 165°.

17. The touch panel display device as claimed in claim 15, wherein the second sloped sidewall comprises an upper portion of the second sloped sidewall and a bottom portion of the second sloped sidewall, and a third angle between the upper portion and the bottom portion of the second sloped sidewall is in a range from about 130° to about 170°.

18. The touch panel display device as claimed in claim 12, wherein the substrate has a top surface and a sidewall, and the sidewall of the substrate comprises an upper portion, a middle portion, and a bottom portion, and an inclination of the upper portion of the sidewall of the substrate, an inclination of the middle portion of the sidewall of the substrate, and inclination of the bottom portion of the sidewall of the substrate are all different.

19. The touch panel display device as claimed in claim 18, wherein an angle between the upper portion of the sidewall of the substrate and the top surface of the substrate is in a range from about 145° to about 155°.

20. The touch panel display device as claimed in claim 17, wherein the substrate has a top surface and a sidewall, the sidewall of the substrate comprises an upper portion, a middle portion, and a bottom portion, and an inclination of the bottom portion of the second sloped sidewall of the second sloped sidewall of the light shielding layer and an inclination of the upper portion of the sidewall of the substrate are substantially equal to each other.
